(19) United States
(12) Patent Application Publication
(10) Pub. No.: US 2023/0176001 A1
(43) Pub. Date: Jun. 8, 2023

(54) ASSEMBLY OF SAMPLE VESSEL AND MEASUREMENT ELECTRONIC UNIT

(71) Applicant: INNOME GMBH, Espelkamp (DE)

(72) Inventors: Mattias Benedikt SCHUH, Obersüssbach (DE); Eike Wilhelm KOTTKAMP, Lübbecje (DE); Florian PICHLER, Munich (DE)

(73) Assignee: INNOME GMBH, Espelkamp (DE)

(21) Appl. No.: 17/996,622

(22) PCT Filed: Apr. 14, 2021
(86) PCT No.: PCT/EP2021/059696

§ 371 Date: Oct. 20, 2022

(30) Foreign Application Priority Data
Apr. 21, 2020 (DE) 10 2020 002 390.8

(51) Int. Cl. G01N 27/22

(52) U.S. Cl. CPC G01N 27/226

(57) ABSTRACT

An assembly made up of a sample vessel having at least one sample chamber for accommodating a sample, at least one electrically operated measuring sensor connected detachably or non-detachably to the sample vessel during the production of the sample vessel, and using which at least one in particular biological, chemical, and/or physical parameter of a sample located in the sample chamber is measurable, and at least two contact elements connected to the measuring sensor via electrical lines connected to the sample vessel, and made up of a measurement electronic unit for operating the measuring sensor and for wirelessly passing on measurement signals of the measuring sensor to a remote receiving unit, wherein the measurement electronic unit is detachably electrically connected to the two contact elements of the sample vessel and detachably fastened on the sample vessel, in particular by fastening one or the housing thereof on the sample vessel.

### CROSS REFERENCE TO RELATED APPLICATIONS

This application is the US national phase of and claims the benefit of and priority on International Application No. PCT/EP2021/059696 having an international filing date of 14 Apr. 2021, which claims priority on and the benefit of German Patent Application No. 10 2020 002 390.8 having a filing date of 21 Apr. 2020.

### BACKGROUND OF THE INVENTION

### Technical Field

The present invention relates to a sample vessel having at least one sample chamber and at least one measuring sensor and measurement electronics for operating the measuring sensor.

### Prior Art

Assigning measuring sensors to sample vessels, such as multi-well plates, petri dishes, Erlenmeyer flasks, etc., is known in order to measure parameters of the sample, for example, temperature, impedance, and the like. The samples can be, inter alia, biological samples, such as cells, but also samples of other types, such as chemical samples.

In general, for this purpose separate measuring sensors permanently connected to the measurement electronics via cable connections are positioned and aligned by the respective user in the sample chamber of the sample vessel. The measurement can subsequently be carried out. After completion of the measurement, the measurement electronics including the measuring sensor are taken out again and removed.

This has the disadvantage, inter alia, that in this constellation a continuous detection of measurement results of the sample is difficult to implement in the laboratory daily routine. This is because, for example, in order to be able to safely transport the sample vessel, the measuring sensor, and the measurement electronics in a laboratory from one location to another location, as often occurs, due to the permanent cable connection of measuring sensor and measurement electronics, on the one hand, and the fact that the measurement electronics are placed separately adjacent to the sample vessel, on the other hand, in general the measuring sensor first has to be removed from the sample vessel in a complex manner and transported separately together with the measurement electronics.

### BRIEF SUMMARY OF THE INVENTION

Proceeding therefrom, it is the object of the present invention to specify a sample vessel and measurement electronics, using which a continuous detection of measured values of samples contained in the sample vessels is possible in a simple manner even in the event of frequent location changes of the sample vessels.

This object is achieved by an assembly made up of a sample vessel and a measurement electronic unit, the assembly made up of a sample vessel, which has at least one sample chamber for accommodating a sample, at least one electrically operated measuring sensor, which is connected detachably or non-detachably to the sample vessel, in particular during the production of the sample vessel, and using which at least one in particular biological, chemical, and/or physical parameter of a sample located in the sample chamber is measurable, and at least two contact elements, which are connected to the measuring sensor via electrical lines connected to the sample vessel, and made up of a measurement electronic unit for operating the measuring sensor and for wirelessly passing on measurement signals of the measuring sensor to a remote receiving unit, wherein the measurement electronic unit is detachably electrically connected to the two contact elements of the sample vessel and wherein the measurement electronic unit is detachably fastened on the sample vessel, in particular by fastening one or the housing thereof on the sample vessel. Furthermore, the object is achieved by a sample vessel for an assembly which has at least one sample chamber for accommodating a sample, a measuring sensor, which is connected detachably or non-detachably to the sample vessel, and using which at least one parameter of a sample located in the sample chamber is measurable, and at least two contact elements, which are connected to the measuring sensor via electrical lines connected to the sample vessel, wherein the contact elements are detachably electrically connectable to the measurement electronic unit and wherein the sample vessel is designed in such a way that the measurement electronic unit is detachably fastenable on the sample vessel, and a measurement electronic unit for such an assembly for operating the measuring sensor of the sample vessel and for wirelessly passing on measurement signals thereof to a remote receiving unit, wherein the measurement electronic unit is detachably electrically connectable to the two contact elements of the sample vessel and wherein the measurement electronic unit, in particular a housing thereof, is detachably fastenable on the sample vessel.

Accordingly, such an assembly has, on the one hand, a sample vessel, which has at least one sample chamber for accommodating a sample, an electrically operated measuring sensor, which is connected detachably or non-detachably to the sample vessel, in particular during the production of the sample vessel, and using which at least one in particular biological, chemical, and/or physical parameter of a sample located in the sample chamber is measurable, and at least two (electrical) contact elements, which are connected to the measuring sensor via electrical lines connected to the sample vessel. Furthermore, the assembly has a measurement electronic unit for operating the measuring sensor and for wirelessly passing on (via electromagnetic waves, such as WLAN, etc.) measurement signals of the measuring sensor to a remote receiving unit, wherein the measurement electronic unit is detachably electrically connected to the two contact elements of the sample vessel and wherein the measurement electronic unit is detachably fastened on the sample vessel, in particular by fastening one or the housing thereof on the sample vessel.

It is therefore provided according to the invention that a measurement electronic unit, which has the required components to be able to carry out measurement processes by means of a measuring sensor connected thereto, is detachably fastened directly on a sample vessel having a measuring sensor and at the same time a detachable electrical connection is created between the measurement electronic unit and the measuring sensor of the sample vessel.

In this way, inter alia, the possibility is provided of moving the assembly made up of sample vessel and measurement electronic unit in a simple and secure manner as a compact overall unit from a first location to another location, without having to disconnect the measuring sensor and/or the measurement electronic unit from the sample vessel. This can make it possible to be able to continue the measurements on the sample at the other location in a quasi-seamless manner. In this way, the sample could be subjected to various processes or measures at various locations in the same sample vessel, while the measurements are continued (continuously or periodically) on the sample and the measurement results or measurement signals can be transmitted, for example, to a central receiving unit and supplied to a further evaluation.

In that the fastening of the measurement electronic unit on the sample vessel, like the electrical connection between the measuring sensor and the measurement electronic unit, is designed to be detachable, it is moreover conceivable to provide sample vessels having measuring sensors as disposable articles, for example, which can be discarded separately after use, so that they do not necessarily have to be cleaned in a complex manner. The (more cost-intensive) measurement electronic unit, in contrast, can be detached from the sample vessel after use and used for another sample vessel.

The measurement electronic unit can preferably have contact elements adapted to the contact elements of the sample vessel, which are each brought into contact with one of the contact elements of the sample vessel to form the electrically conductive connection or are each brought into contact upon connection of these components.

The detachable electrical connection between the respective contact means of the sample vessel and the respective contact means of the measurement electronic unit can be based in each case on a form fit and/or friction lock of the contact elements, in particular while resting on one another. However, it is also conceivable that the contact means only press against one another without such a form fit or friction lock.

In one particularly important refinement of the concept according to the invention, the measuring sensor can be part of a film sensor, which is detachably or non-detachably connected to the sample vessel and preferably has multiple measuring sensors. Film sensors are known in the prior art and are particularly cost-effective to produce. The respective film sensor can be connected to the sample vessel during the production of the sample vessel in this case, for example, so that in other words the connection procedure is integrated into the production process of the sample vessel. However, it is also conceivable to subsequently connect the film sensor to the sample vessel or attach it thereon. For example, a user could undertake this, who attaches the film sensor immediately before the use thereof on location in a laboratory.

The film sensor, in particular a large-area side of the film sensor, can preferably form the bottom of the sample vessel.

This is in particular in such a way that the film sensor, in particular a region of the film sensor (or the above-mentioned large-area side thereof) comprising the measuring sensor forms the bottom of the sample chamber, which is preferably open on top, so that a sample located in the sample chamber would be seated on this side of the film sensor or would be facing toward it and the measuring sensor can contact the sample.

With regard to the sample vessel, it can thus have a preferably injection-molded sample vessel body made of plastic or a sample vessel body made of glass, in which the (at least one) sample chamber is then formed.

The film sensor can then be attached non-detachably or detachably on the sample vessel body of the sample vessel, in particular on its lower side, preferably—as indicated above—while forming the bottom of the sample chamber.

It is alternatively also conceivable that the sample vessel body of the sample vessel is formed directly from a film sensor having measuring sensor. The film sensor forming the sample vessel body could then be formed into the sample vessel body, for example in a thermoforming process.

The sample vessel can moreover have multiple separate sample chambers, to each of which a separate measuring sensor is assigned, in particular a film sensor in each case having a measuring sensor of the multiple measuring sensors, preferably at the same time forming the bottom of the respective sample chamber in each case.

Of course, the bottom of each of these sample chambers of the sample vessel can then be formed here by the film sensor, in particular in each case by a respective region of the film sensor (or the corresponding large-area side thereof), in each of which a measuring sensor is located, so that this can then contact a sample located in the sample chamber.

The one, the multiple or each sample chamber can moreover (each) be formed by a cavity, which extends while forming a (respective) opening of the sample chamber in an outer side of the sample body, in particular in an outer side of a/the bottom of the sample body, through the sample body to this outer side, wherein this (respective) opening of the sample chamber in the outer side of the sample body is covered liquid-tight by the film sensor.

The film sensor can be detachably fastened here on this outer side of the sample body, in particular by means of detachable adhesive, or non-detachably. The film sensor can then partially or completely cover this outer side of the sample body, in particular while covering all sample chamber openings in this outer side.

Moreover, the film sensor, in particular a large-area side thereof, preferably a side thereof facing away from the outer side of the sample body, can form an outer side of the sample vessel itself.

With regard to what the measurement electronic unit includes, it can thus have an ND converter for converting analog signals of the measuring sensor into digital signals and/or a transmitting unit for wirelessly transmitting signals, in particular of the measuring sensor, to a remote receiving unit, in particular by means of radio, and/or an electronic microchip.

With regard to the sample vessel, it can thus have an ID code uniquely identifying the sample vessel, in particular a data matrix code.

The measurement electronic unit can then in this context have a detection device for automatically, in particular wirelessly, detecting this ID code, so that this ID code is read in automatically when the measurement electronics are connected to the sample vessel.

For the above-mentioned detachable fastening of the measurement electronic unit on the sample vessel, at least one connecting means arranged on the measurement electronic unit, in particular on its housing, can interact with the sample vessel, in particular with a connecting means arranged on the sample vessel, preferably while forming a detachable form fit and/or friction lock.

Furthermore, it can be provided that the sample vessel has a receptacle region in which the contact elements are arranged and in which the measurement electronic unit is fitted. This is in particular in such a way that an outer side of the measurement electronic unit, in particular an outer side of a or the housing of the measurement electronic unit, does not protrude outward in relation to outer sides of the sample vessel adjoining the receptacle region.

Furthermore, it can be provided that the measurement electronic unit has one or more sensors for measuring one or more parameters of the surroundings of the measurement electronic unit, in particular the temperature, the movement, the humidity, and/or the pressure of the (gaseous) medium surrounding the measurement electronic unit, in particular the surrounding air, and/or the ambient brightness. The one or more sensors can be arranged on a or the housing of the measurement electronic unit and/or can be connected thereto and/or can be arranged inside the housing.

Further features of the present invention result from the appended patent claims, the following description of a preferred exemplary embodiment, and from the appended drawings.

### BRIEF DESCRIPTION OF THE DRAWINGS

In the figures:

FIG. 1 shows a sample vessel and a film sensor of the sample vessel of an assembly according to the invention in an exploded view, in a viewpoint diagonally from below;

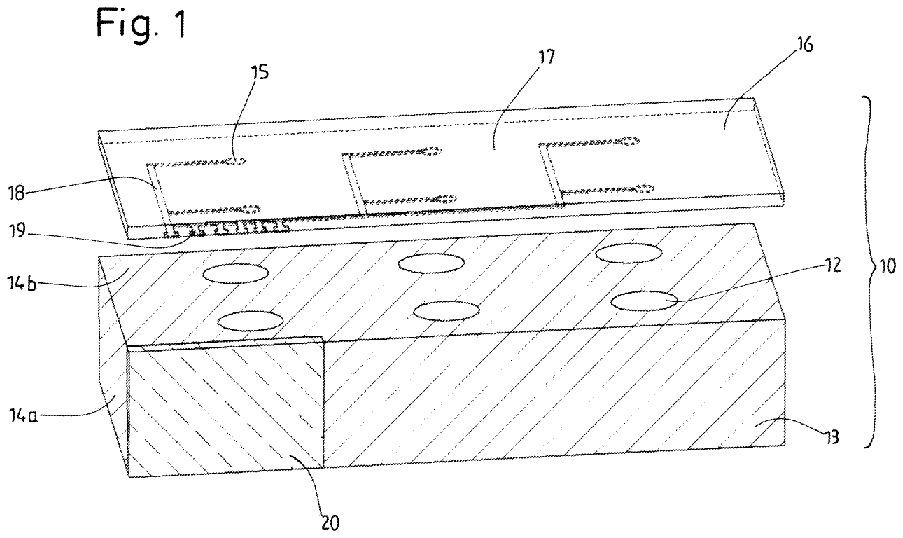

FIG. 2 shows the sample vessel and the film sensor in an exploded view, in a viewpoint diagonally from above;

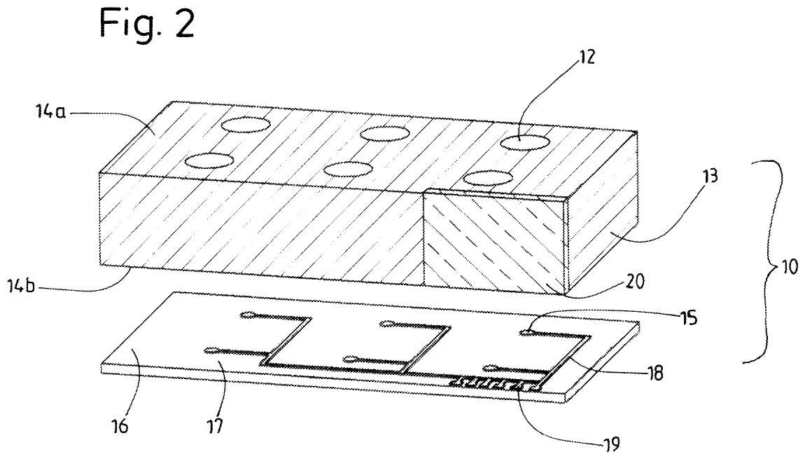

FIG. 3 shows a view similar to FIG. 1, but having film sensor fastened on the sample vessel;

FIG. 4 shows a view similar to FIG. 2, supplemented with a measurement electronic unit for the sample vessel of the assembly according to the invention, specifically in a state in which the measurement electronic unit is not connected to the sample vessel; and

FIG. 5 shows a view similar to FIG. 4, but in a state of the measurement electronic unit fastened on the sample vessel.

### DETAILED DESCRIPTION OF PREFERRED EMBODIMENTS

An embodiment according to the invention of a sample vessel 10 and a measurement electronic unit 11, which together form a or the assembly according to the invention, is shown in the figures.

The sample vessel 10 is schematically shown as a cuboid block in the present case, in which individual sample chambers 12 spaced apart from one another are arranged. The sample chambers 12 are used to accommodate samples, such as biological samples, for example cells or the like. However, greatly varying other types of samples can also be used. The type of the samples is not important according to the invention.

In the present case, the sample chambers 12 are hollow-cylindrical continuous recesses from an upper side 14a to a lower side 14b in a sample vessel body 13 of the sample vessel 10. These recesses accordingly extend in the present case from the upper side 14a of the sample vessel body 13 to the lower side 14b. It is obvious that the sample chambers 12 can also be formed differently. For example, it is also conceivable that the sample vessel 10 only has one sample chamber 12.

Each sample chamber 12 is assigned a separate, electrically operated measuring sensor 15, which can detect one or more parameters of a sample located in the respective sample chamber 12. These can be greatly varying types of biological, chemical, and/or physical parameters, the precise nature thereof is not important. For example, the temperature or the impedance of the sample could be measured.

In the present case, the individual measuring sensors 15 arranged in a grid are part of a film sensor 16.

The film sensor 16 has a film blank 17, in particular made up of two or more layers connected to one another, to which electrical lines or conductor tracks 18 are connected. These can be embedded in a known manner, for example, between two film layers.

Electrical contact elements 19 of the film sensor 16, formed in the present case as contact surfaces, are connected to the conductor tracks 18.

Two contact elements 19 are respectively assigned to each measuring sensor 15.

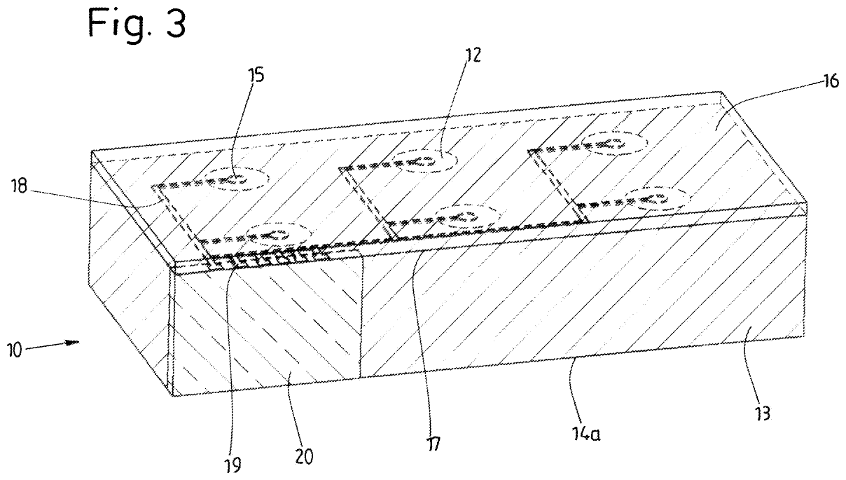

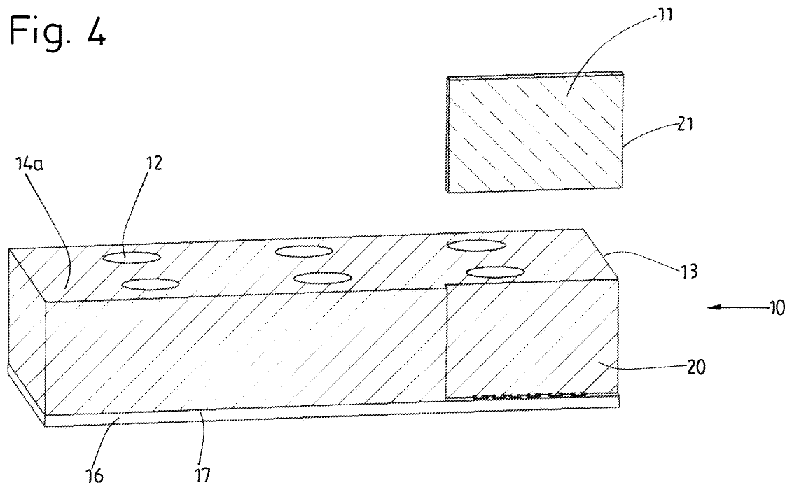

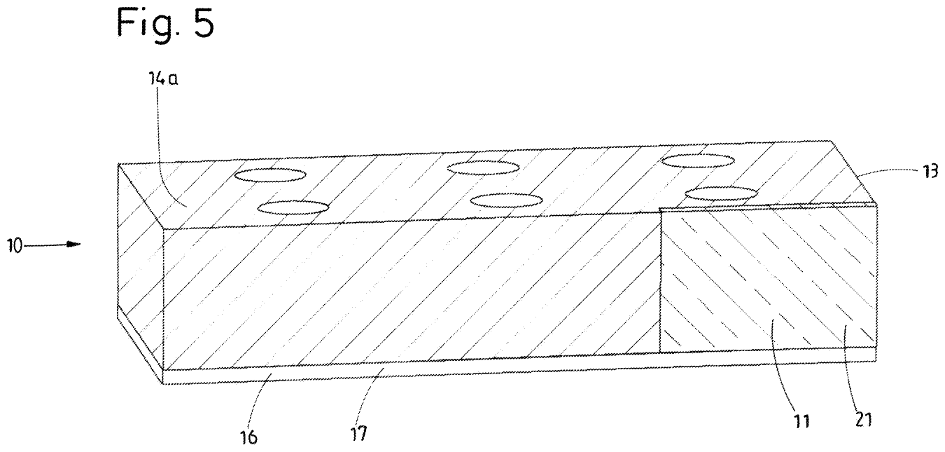

The entire film sensor 16 is fastened by means of detachable adhesive on the lower side 14b of the sample vessel body 13. In the present case, it forms the bottom or an outer side of the sample vessel 10, cf. FIGS. 3 to 5 (in the fastened state of the film).

The film sensor 16 is formed and arranged on the lower side 14b of the sample vessel body 13 in such a way that one measuring sensor 15 of the plurality of the measuring sensors 15 of the film sensor 16 is respectively assigned to each sample chamber 12.

A corresponding section of the film sensor 16, in which the respective measuring sensor 15 is arranged, forms the bottom of the sample chamber 12 assigned to it in each case.

The film sensor 16 can alternatively also be fastened using non-detachable or permanent adhesive on the lower side 14b.

In the fastened state of the film sensor 16, the contact elements 19 are arranged in an installation or receptacle region 20 of the sample vessel 10, which forms a cutout or a recess in the cuboid sample vessel 10.

In this receptacle region 20, the measurement electronic unit 11 can be connected, in particular in a form-fitting and/or friction-locked manner, to the sample vessel 10 or the sample vessel body 13.

Specifically, the measurement electronic unit 11 is fastened in this receptacle region 20 on the sample vessel 10 or the sample vessel body 13. For example, by means of clip connections (not explicitly shown), connecting rails adapted to one another, or various other connecting means which the sample vessel 10/the sample vessel body 13 and/or the measurement electronic unit 11 can have.

This fastening takes place so that the measurement electronic unit 11 can be detachably fastened on the sample vessel 10.

Upon the fastening, in each case electrical contact elements (not explicitly shown) of the measurement electronic unit 11 are brought into electrically conductive contact with assigned contact elements 19 of the sample vessel 10 or the film sensor 16 of the sample vessel 10 to form a respective electrical connection.

In the present case, the measurement electronic unit 11, namely the housing 21 thereof, is adapted to the dimensions of the receptacle region 20, specifically in such a way that an outer side of the housing 21 does not protrude outward in relation to the outer sides of the sample vessel 10 adjoining the receptacle region 20. A particularly compact overall unit of sample vessel 10 and measurement electronic unit 11 is created in this way.

The measurement electronic unit 11 is used to operate the measuring sensors 15 and to wirelessly transmit the measurement signals originating from the measuring sensors 15, which arise upon measurement of the corresponding parameters of the sample, to a remote receiving unit (not shown). The measurement signals can possibly be transmitted in processed form here.

The measurement electronic unit 11 can thus have an IC and an analog-to-digital (A/D) converter. In the measurement mode, the measurement electronic unit 11 can then receive analog measurement signals of the measuring sensors 15, convert them into digital signals, and transmit them wirelessly to the remote receiving unit.

The remote receiving unit can in this case be, for example, part of a computer device, which comprises an analysis device, using which the received measurement signals are evaluated in a known manner.

The measurement electronic unit 11 can, for example, have a corresponding radio module (WLAN/Bluetooth etc.) for transmitting the wireless signals. The measurement electronic unit 11 can, of course, also additionally have a corresponding receiver for receiving wireless signals, for example for receiving signals which are used to control the measurement electronic unit 11.

The measurement electronic unit 11 furthermore has a separate energy supply module, for example a battery or an accumulator, using which the power-consuming components of the measurement electronic unit 11 and, if necessary, the measuring sensors 15 of the film sensor 16 can be supplied with electric current.

Alternatively, however, it is also conceivable to provide a separate power supply unit, for example an electric transformer, to which the measurement electronic unit 11 is connected via electrical cable lines.

After completion of the measurement mode, both the detachably fastened film sensor 16 and also the detachably fastened measurement electronic unit 11 can be detached from the sample vessel body 13, so that the sample vessel body 13 can either be cleaned in a simple manner or—if it is designed as a disposable article—can be discarded. In particular the (expensive) measurement electronic unit 11 can be used further, however, for another sample vessel 10 of the same or similar construction.

The film sensor 16 is generally also discarded after being detached from the sample vessel 10. However, it is also conceivable to use the film sensor 16 further and attach it to another sample vessel body 13.

The measurement electronic unit 11 itself can moreover also have one or more sensors for measuring one or more parameters of the surroundings in which the assembly made of sample vessel 10 and measurement electronic unit 11 is respectively located. For example, the ambient temperature, the humidity of the medium surrounding the assembly, the pressure thereof (air pressure), the ambient brightness, etc. could be measured by the sensors of the measurement electronic unit 11.

As a person skilled in the art recognizes, greatly varying variants of the design of the measurement electronic unit 11 and the sample vessel 10 are conceivable without leaving the inventive concept.

### LIST OF REFERENCE SIGNS

10 sample vessel

11 measurement electronic unit

12 sample chamber

13 sample vessel body

14a upper side

14b lower side

15 measuring sensor

16 film sensor

17 film blank

18 conductor track

19 contact element

20 receptacle area

21 housing

1. An assembly of comprising:
a sample vessel (10), which has at least one sample chamber (12) for accommodating a sample;
at least one electrically operated measuring sensor (15), which is connected detachably or non-detachably to the sample vessel (10), in particular during the production of the sample vessel (10), and using which at least one in particular biological, chemical, and/or physical parameter of a sample located in the sample chamber (12) is measurable; and
at least two contact elements, which are connected to the measuring sensor (15) via electrical lines connected to the sample vessel (10), and made up of a measurement electronic unit (11) for operating the measuring sensor (15) and for wirelessly passing on measurement signals of the measuring sensor (15) to a remote receiving unit,
wherein the measurement electronic unit (11) is detachably electrically connected to the two contact elements of the sample vessel (10), and
wherein the measurement electronic unit (11) is detachably fastened on the sample vessel (10), in particular by fastening one or the housing thereof on the sample vessel (10).

2. The assembly as claimed in claim 1, wherein the measurement electronic unit (11) has contact elements adapted to the contact elements of the sample vessel (10), which are each brought into contact with one of the contact elements of the sample vessel (10) to form an electrically conductive connection.

3. The assembly as claimed in claim 2, wherein the detachable electrical connection between the respective contact means of the sample vessel (10) and the respective contact means of the measurement electronic unit (11) is based in each case on a form fit and/or friction lock between the contact elements, and/or in that the respective contact means of the sample vessel (10) and the respective contact means of the measurement electronic unit (11) press against one another with contact to form the electrical connection.

4. The assembly as claimed in claim 1, wherein the measuring sensor (15) is part of a film sensor, which is detachably or non-detachably connected to the sample vessel (10), in particular during the production thereof, and preferably has multiple measuring sensors (15).

5. The assembly as claimed in one or more of the preceding claims, characterized in that claim 1, wherein the sample vessel (10) has a sample vessel body, in which the sample chamber (12) is formed, wherein the sample vessel body is formed from a film sensor comprising the measuring sensor (15), preferably from a film sensor which was formed in a thermoforming process to form the sample vessel body.

6. The assembly as claimed in claim 1, wherein the sample vessel (10) has a preferably injection-molded sample vessel body made of plastic or a sample vessel body made of glass, in which the sample chamber (12) is formed.

7. The assembly as claimed in claim 4, wherein the film sensor forms the bottom of the sample vessel (10) and/or the sample chamber (12), and/or in that the film sensor is attached non-detachably or detachably to the sample vessel body of the sample vessel (10), in particular to its lower side, preferably while forming the bottom of the sample chamber (12).

8. The assembly as claimed in claim 4, wherein the sample vessel (10) has multiple separate sample chambers (12), to each of which a separate measuring sensor (15) is assigned, in particular one measuring sensor (15) in each case of the film sensor, which has multiple measuring sensors (15) and preferably in each case forms the bottom of the respective sample chamber (12) here.

9. The assembly as claimed in claim 4, wherein the bottom of the, multiple or each sample chamber (12) of the sample vessel (10) is formed by the film sensor, in particular by an area of the film sensor in which the measuring sensor (15) is located, so that it can contact a sample located in the sample chamber (12).

10. The assembly as claimed in claim 4, wherein the sample chamber (12) is formed by a cavity, which, while forming an opening of the sample chamber (12) in an outer side of the sample body, in particular in an outer side of a/the bottom of the sample body, extends through the sample body up to this outer side, and in that this opening of the sample chamber (12) in the outer side of the sample body is covered liquid-tight by the film sensor.

11. The assembly as claimed in claim 10, wherein the film sensor is fastened detachably, in particular by means of detachable adhesive, or non-detachably on this outer side of the sample body, and in that the film sensor partially or completely covers this outer side, in particular while covering all sample chamber openings in this outer side.

12. The assembly as claimed in claim 10, wherein the film sensor, in particular a large-area side thereof, preferably a side of the film sensor facing away from the outer side of the sample body, forms an outer side of the sample vessel (10).

13. The assembly as claimed in claim 1, wherein the measurement electronic unit (11) has an ND converter for converting analog signals of the measuring sensor (15) into digital signals and/or a transmitting unit for wirelessly transmitting signals, in particular of the measuring sensor (15), to a remote receiving unit, in particular by means of radio, and/or an electronic microchip.

14. The assembly as claimed in claim 10, wherein the sample vessel (10) has an ID code uniquely identifying the sample vessel (10), in particular a data matrix code.

15. The assembly as claimed in claim 14, wherein the measurement electronic unit (11) has a detection device for automatic, in particular wireless detection of the ID code.

16. The assembly as claimed in claim 1, wherein, for the detachable fastening of the measurement electronic unit (11) on the sample vessel (10), at least one connecting means arranged on the measurement electronic unit (11), in particular on its housing, interacts with the sample vessel (10), in particular with a connecting means arranged on the sample vessel (10), preferably while forming a detachable form fit and/or friction lock.

17. The assembly as claimed in claim 1, wherein the sample vessel (10) has a receptacle area, in which the contact elements are arranged and in which the measurement electronic unit (11) is fitted, in particular in such a way that an outer side of the measurement electronic unit (11), in particular an outer side of one or the housing of the measurement electronic unit (11), does not protrude outward in relation to the outer sides of the sample vessel (10) adjoining the receptacle area.

18. The assembly as claimed in claim 1, wherein the measurement electronic unit (11) has one or more sensors for measuring one or more parameters of the surroundings of the measurement electronic unit (11), in particular the temperature, the movement, the humidity, and/or the pressure of the (gaseous) medium surrounding the measurement electronic unit (11), in particular the surrounding air and/or the ambient brightness.

19. A sample vessel for an assembly, which has at least one sample chamber (12) for accommodating a sample, a measuring sensor (15), which is connected detachably or non-detachably to the sample vessel (10), and using which at least one parameter of a sample located in the sample chamber (12) is measurable, and at least two contact elements, which are connected to the measuring sensor (15) via electrical lines connected to the sample vessel (10), wherein the contact elements are detachably electrically connectable to the measurement electronic unit (11) and wherein the sample vessel (10) is designed in such a way that the measurement electronic unit (11) is detachably fastenable on the sample vessel (10).

20. (canceled)

21. A measurement electronic unit for an assembly for operating a measuring sensor (15) of a sample vessel (10) and for wirelessly passing on measurement signals thereof to a remote receiving unit, comprising a measurement electronic unit (11) that is detachably electrically connectable to two contact elements of the sample vessel (10) and wherein the measurement electronic unit (11), in particular a housing thereof, is detachably fastenable on the sample vessel (10).

22. (canceled)
